(19) United States
(12) Patent Application Publication
(10) Pub. No.: US 2021/0112629 A1
(43) Pub. Date: Apr. 15, 2021

(54) METHOD FOR MANUFACTURING AN ELECTRICAL HEATING ELEMENT FOR ELECTRICAL HEATING DEVICES AND/OR LOAD RESISTORS

(71) Applicant: Türk & Hillinger GmbH, Tuttlingen (DE)

(72) Inventor: Andreas SCHLIPF, Tuttlingen (DE)

(21) Appl. No.: 17/070,505

(22) Filed: Oct. 14, 2020

(30) Foreign Application Priority Data
Oct. 15, 2019 (DE) 10 2019 127 753.1

(51) Int. Cl. H05B 3/02

(52) U.S. Cl. CPC H05B 3/02

(57) ABSTRACT

A method for manufacturing an electrical heating element is provided, especially for electrical heating devices and load resistors. The method includes the steps of defining at least one heating conductor, providing a heating element blank with geometric dimensions that are selected such that the defined at least one heating conductor can be arranged in a sub-volume of a space taken up by material of the heating element blank, and machining the heating element blank, so that the defined at least one heating conductor is generated by removing material from the heating element blank.

### CROSS-REFERENCE TO RELATED APPLICATION

This application claims priority under 35 U.S.C. § 119 to German Patent Application No. 10 2019 127 753.1, filed on Oct. 15, 2019, the disclosure of which is incorporated herein by reference in its entirety.

### BACKGROUND OF THE INVENTION

Up to now, electrical heating elements for electrical heating devices—especially heating cartridges, tubular heating elements, hollow cartridges, flat heating elements, and surface-area heating elements—and/or load resistors, with which electrical energy is converted into heat, have been typically manufactured by providing a heating conductor material in the form of a wire and this wire is then bent, wound, or coiled—unless it is used in a stretched-out shape—either on a carrier or freely as a spatial curve, in order to generate the desired heating conductor, with which the desired heat distribution or, in the case of load resistors, heat dissipation, can be achieved.

Apart from the problem that not every conceivable or desirable spatial curve can be generated in this way, there are particular problems in configurations, in which small heating conductor resistors with large heating conductor cross sections must be accommodated in a narrow space, especially so that, on one hand, thermal cycling loads over long periods of time can be withstood and so that, on the other hand, process-assured unheated zones and heated zones can be connected to each other for an electrical heating device, which is essential especially for very high current loads.

### BRIEF SUMMARY OF THE INVENTION

The task of the preferred invention is to specify an economical method for manufacturing an electrical heating element that is suitable for at least reducing the problems specified above. This task is achieved by a method for manufacturing an electrical heating element with the characteristics of device and method described herein. Advantageous refinements of the preferred invention are the subject matter of the respective dependent claims.

The method according to the invention for manufacturing an electrical heating element, which is suitable especially for heating elements used for electrical heating devices and load resistors, has the steps
defining at least one heating conductor
preparing a heating element blank with geometric dimensions that are selected such that the defined heating conductors can be arranged in a sub-volume of the space taken up by the material of the heating element blank, and
machining the heating element blank, so that the defined heating conductors are generated by removing material from the heating element blank.

Due to these measures, the heating conductor is machined to some extent from the heating element blank (which does not preclude that it is not deformed later as a whole), as has been typical for a long time, by deformation of a heating conductor prepared typically as a wire or ribbon. The method according to the invention has several important advantages:

First, it can be easily performed in a fully automated way, which is associated with cost advantages, but also higher processing reliability and reproducibility and reduction of excess scrap and thus has positive effects on series production. These effects also compensate for the higher use of materials, which could make this process seem unsuitable at first; in addition, the material removed in the course of the manufacturing process can be recycled very well.

Second, the method makes possible heating conductor geometries that were not previously possible for various reasons. For example, it has proven practically unrealizable to wind ribbon heating conductors with a large cross section into a structure with a small radius and large curvature, so that the resulting electrical heating element has a small diameter. It was also not possible to wind wide ribbons with a large coil pitch or to realize complex, for example, nested heating conductor geometries.

Possible machining techniques that could be used are, in particular, metal-cutting machining, laser machining—especially fine laser cutting, water jet cutting—especially fine water jet cutting, punching, and—especially in the case of relatively filigree heating element blanks—fine punching or etching.

The prepared heating element blanks can have basically any shape, as long as the defined heating element conductor can be inscribed into the volume defined by this shape, which is the prerequisite so that it can be machined from such a heating element blank and is also associated, in particular, with the fact that the defined heating conductors can be arranged in a sub-volume of the space taken up by the material of the heating element blank.

In practice, however, it has been shown in the wide majority of cases that heating element blanks with a simple base geometry, especially with a block-shaped, (solid) cylindrical, or tubular base geometry can be used, which can be prepared by cutting sections of suitable length from a strip material with a corresponding cross section. These simple base geometries of the heating element blanks are to be preferred in many cases due to their simple handling and economical procurability.

Simple and economical procurability of the heating element blank, however, is not the only valid criterion for the heating element blank to be used. For example, it can be advantageous if a heating element blank is prepared that has sections and/or layers that are made from different materials or contain different materials. For example, a heating element blank can be used in one advantageous variant with a layer made from a heating element alloy and a layer made from copper, for example, in the shape of a composite tube or a two-layer plate, in order to realize heating conductors that have unheated sections. While the copper layer in the heated sections is removed in the machining step, it remains in the unheated section and then drastically reduces the resistance in these sections, so that there is almost no heating output there. Even for complex heating conductor profiles, arrangements of unheated zones are made possible that could not be previously realized.

If a heating element blank is prepared in one advantageous refinement of the invention, which has at least one section, area, or layer that consists of a resistive alloy with a temperature coefficient >300 ppm, preferably >1000 ppm, especially preferred >3000 ppm, it is possible to control and/or monitor the temperature of the electrical heating element.

Another criterion that can influence the selection of a heating element blank for a given heating conductor is that, possibly through the selection of a suitable geometry of the blank, the subsequent machining step can be performed significantly faster and/or easier. For example, if a heating element blank is prepared that has sections with different thicknesses, a heating conductor with sections in which the heating conductor has a different cross section can be realized, under some circumstances with a simple punching step, which otherwise would have to be manufactured by selective cutting away of the heating conductor for changing the cross section. The heating element blank with sections of different thickness can also be generated here from a heating element blank with simpler base geometry, for example, by grinding or milling in some areas.

In an especially simple way, a plurality of machining methods, with which the defined heating conductor is realized by machining the heating element blank, can be performed if the heating conductor is defined so that it has a flat profile.

One option for achieving this, which, however, is not limited to flat heating conductors as the target geometry, consists in that the heating conductor is defined so that it is produced by a global geometric transformation, in particular, by unrolling or unfolding from a final heating conductor and the machined heating element blank is subjected to the inverse geometric transformation, in particular, by rolling up or folding together, in order to bring the electrical heating element into the shape in which it has the final heating conductor.

One advantageous variant of the defined heating conductor provides that the heating conductor is defined so that it has sections of different width, so that it is locally widened or narrowed. This leads to a cross-sectional variation that causes a local variation in resistance in the corresponding sections and thus a corresponding local change to the temperature profile of the electrical heating element. Alternatively or additionally, this effect can also be achieved such that the heating conductor is defined so that it has sections of different thickness.

The heating element blank preferably consists of a heating conductor alloy, including in particular alloys of two or more metals that have a high specific electrical resistance and a low tendency to oxidation, or of a layer structure made of such a heating conductor alloy and a further layer which consists of a metal with a lower specific electrical resistance. Examples of such heat conductor alloys include, in particular:
Copper-nickel-manganese alloys such as Nickelin, Manganin and Constantan;
Two-component and three-component alloys based on nickel and chromium, e.g. Chromin, Chromel A, Chromel B or Chromel C; or
Alloys of iron and chromium with added aluminum, especially chrome steel or Kanthal. An example of the material of the second layer is copper.

Another option for influencing the temperature profile of the electrical heating element consists in defining the heating conductor so that it has a coiled profile in some sections, with a varied coil pitch.

The heating conductor can also be defined so that it has a coiled profile in some sections, with a varied rotational direction of the coils.

Another large advantage of electrical heating elements that are manufactured by means of the method according to the invention is that a high-grade, process-assured contacting can be achieved. This is the case especially when the heating conductor is defined so that it has contact surfaces for the electrical contacting or connections. These contact surfaces or connections are also part of the electrical heating element itself and not an intermediate element, by means of which the contacting is realized.

In the variant specified first, local contact problems can be eliminated by preparing the enlarged contact surface, while in the variant specified second, a connection of defined contact conditions is created, wherein, in contrast to the previous use of connections, no additional contact point is created between the connection and the electrical heating element.

With the method according to the invention, it is also possible in one advantageous refinement to define the heating conductor so that it has at least one series circuit of sub-heating conductors and/or at least one parallel circuit of sub-heating conductors. Such sub-heating conductors can preferably also be realized so that they can be controlled or operated switchable from each other. The heating conductor can also be realized in an advantageous way so that they have at least two heating circuits that are separate from each other.

All this illustrates that, through the manufacturing method according to the invention, a considerably more complex functionality of the electrical heating element is made possible.

In another advantageous construction of the method, the heating conductor is defined so that it has at least one bifilar section. In this way, induction effects in particular can be reduced.

It is further possible to sustain the mechanical effects of thermal load cycling through suitable definition of the heating conductor.

### BRIEF DESCRIPTION OF THE SEVERAL VIEWS OF THE DRAWING

The foregoing summary, as well as the following detailed description of the preferred invention, will be better understood when read in conjunction with the appended drawings. For the purpose of illustrating the preferred invention, there are shown in the drawings embodiments which are presently preferred. It should be understood, however, that the invention is not limited to the precise arrangements and instrumentalities shown. In the drawings:

FIG. 1a is a side perspective, exploded view of a first example of an electrical heating element in an exterior view;

FIG. 1b is a side elevational, partial cross-sectional view of the electrical heating element from FIG. 1a in a partially opened view;

FIG. 2a is a side perspective, exploded view of a second example of an electrical heating element in an exterior view;

FIG. 2b is a side elevational, partial cross-sectional view of the electrical heating element from FIG. 2a in a partially opened view;

FIG. 3a is a side perspective view of a fourth example of an electrical heating conductor in an exterior view;

FIG. 3b is a top plan view of the electrical heating conductor from FIG. 3a;

FIG. 3c is a side perspective, exploded view of the electrical heating element from FIG. 3a in a rolled-up state in an exterior view;

FIG. 3d is a side elevational view of the electrical heating element from FIG. 3a in the rolled-up state from FIG. 3c;

FIG. 3e is a front elevational view of a schematic of the global geometric transformation that transforms the heating conductor from FIGS. 3a and 3b into the electrical heating element from FIGS. 3c and 3d;

FIG. 4a is a side perspective view of a fourth example of an electrical heating conductor in an exterior view;

FIG. 4b is a top plan view of the electrical heating conductor from FIG. 4a;

FIG. 4c is a side perspective, exploded view of the electrical heating element from FIG. 4a in a rolled-up state in an exterior view;

FIG. 5a is a side perspective, exploded view of a fifth example of an electrical heating element in an exterior view;

FIG. 5b is a side elevational view of the electrical heating element from FIG. 5a;

FIG. 5c is a side elevational, partial cross-sectional view of the electrical heating element from FIG. 5a in an installation situation;

FIG. 6a is a side perspective view of a sixth example of an electrical heating element in an exterior view;

FIG. 6b is a side elevational, partial cross-sectional view of the electrical heating element from FIG. 6a in an installation situation;

FIG. 7a is a side perspective view of a seventh example of an electrical heating conductor in an exterior view;

FIG. 7b is a side elevational, partial cross-sectional view of the shaped electrical heating element from FIG. 7b in an installation situation;

FIG. 7c is a front elevational view of the global geometric transformation that shapes the electrical heating element and especially the heating conductor from FIG. 7a into the electrical heating element from FIG. 7b;

FIG. 8a is a side perspective view of an eighth example of an electrical heating conductor in an exterior view;

FIG. 8b is a top plan view of the electrical heating conductor from FIG. 8a;

FIG. 8c includes a side perspective, partial fragmentary view and a front elevational view of the electrical heating conductor from FIG. 8a in a state rolled into a circle in an exterior view;

FIG. 8d includes a side perspective, partial fragmentary view and a front elevational view of the electrical heating conductor from FIG. 8a in a state folded into a square in an exterior view;

FIG. 8e includes a side perspective, partial fragmentary view and a front elevational view of the electrical heating element from FIG. 8a in a state rolled into a spiral in an exterior view;

FIG. 8f includes a side perspective, partial fragmentary view and a front elevational view of the electrical heating element from FIG. 8a in a state rolled into a semicircle in an exterior view;

FIG. 9 is a side perspective view of a ninth example of an electrical heating conductor in an exterior view;

FIG. 10 is a side perspective view of a tenth example of an electrical heating conductor in an exterior view;

FIG. 11a is a side perspective, partial fragmentary view of an eleventh example of an electrical heating element in an exterior view;

FIG. 11b is a cross-sectional view of the electrical heating element from FIG. 11a, taken along a longitudinal section of the electrical heating element of FIG. 11a;

FIG. 12a is a side perspective, partial fragmentary view of a twelfth example for an electrical heating element in an exterior view;

FIG. 12b is a side elevational view of the electrical heating element from FIG. 12a;

FIG. 13a is a side perspective, exploded view of parts of an electrical heating device with a tubular metal sheath used as a return line;

FIG. 13b is a side elevational, partial cross-sectional view of the electrical heating device assembled from the parts shown in FIG. 13a in a partially opened view;

FIG. 14 is a side perspective, partial fragmentary view of a fourteenth example of an electrical heating element, which has an integrated connection section;

FIG. 15a is a side perspective view of a fifteenth example of an electrical heating conductor;

FIG. 15b is a top plan view of the machined electrical heating element from which the electrical heating element from FIG. 15a is produced;

FIG. 16a is a side perspective view of a sixteenth example of an electrical heating conductor;

FIG. 16b is a top plan view of the machined electrical heating element from which the electrical heating conductor from FIG. 16a is produced;

FIG. 17 is a side elevational view of a seventeenth example of an electrical heating element;

FIG. 18 is a side elevational view of an eighteenth example of an electrical heating element,

FIG. 19a is a side elevational view of a nineteenth example of an electrical heating element as an exterior view;

FIG. 19b is a side elevational view of the electrical heating element from FIG. 19a;

FIG. 19c is a side elevational schematic view of the reaction of the electrical heating element from FIG. 19a under tensile load;

FIG. 19d is a side elevational schematic view of the reaction of the electrical heating element from FIG. 19a under compressive load;

FIG. 20a is a top plan view of a twentieth example of an electrical heating conductor;

FIG. 20b is a side perspective view of the machined electrical heating element from which the electrical heating conductor from FIG. 20a is produced;

FIG. 21 is a side perspective, partial cross-sectional view of a twenty-first example of an electrical heating element in its installation situation;

FIG. 22 is a side perspective, partial cross-sectional view of a twenty-second example of an electrical heating element in a first installation situation,

FIG. 23 is a side perspective, partial cross-sectional view of a twenty-second example of an electrical heating element in a second installation situation;

FIG. 24 is a side perspective, partial cross-sectional view of a variant of the twenty-second example of the electrical heating element in an installation situation; and

FIG. 25 is a side perspective, partial cross-sectional view of another variant of the twenty-second example of the electrical heating element in an installation situation.

### DETAILED DESCRIPTION OF THE INVENTION

The electrical heating element 10 shown in FIGS. 1a and 1b is manufactured from a tubular heating element blank 11 but could also be manufactured from a cylindrical heating element blank, in which a central hole is later formed.

The space, which was initially taken up by the material of the tubular heating element blank 11, is defined accordingly by the space taken up by its tubular sheath. The electrical heating element 10 is obtained from the tubular heating element blank 11 such that, in the tubular sheath, a groove 12 passing through the tubular sheath is formed, by material of the tubular sheath being removed. Accordingly, heating conductors are formed in a sub-volume of the space originally taken up by material of the heating element blank 11.

The groove 12 formed in this way has the shape of a helical line that has, in this embodiment, in its middle section 12b, a different pitch than in its end sections 12a, 12c. Due to this groove 12 passing through the tubular sheath, a heating conductor is produced with coils 13, whose cross section 14b in the middle section 12b of the groove 12 is larger due to its larger width b than the cross section 14a, 14c in the end sections 12a, 12c of the groove 12. Accordingly, a lower heat output is produced in the area of the middle section 12b of the groove 12.

It is to be noted that the tubular shape of the heating element blank 11 is retained at the two ends of the heating element 10 so that the heating element conductor has, at these ends of the heating element 10, large contact surfaces 15a, 15b formed by the tube inner wall, by means of which a process-assured contact to a not-shown connector pin can be formed, for example, as a press-fit contact. Such contact surfaces 15a, 15b of the heating element 10 are obviously located analogously in a series of embodiments described below, even if they are not always mentioned explicitly.

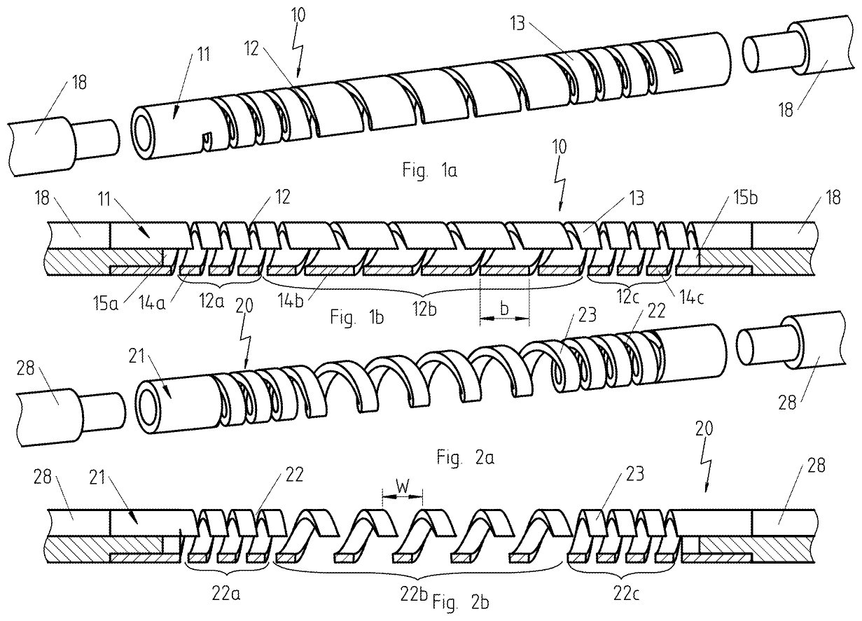

The electrical heating element 20 shown in FIGS. 2a and 2b is also manufactured from a tubular heating element blank 21. The electrical heating element 20 is also obtained from the tubular heating element blank 21 such that, in the tubular sheath, a groove 22 passing through the tubular sheath was formed by material being removed from the tubular sheath.

The formed groove 22 has the shape of a helical line, which has, however, in this embodiment, a different pitch and a different width in its middle section 22b than in its end sections 22a, 22c. Through this grove 22 passing through the tubular sheath, a heating conductor is created with coils 23, whose coil distance W in the middle section 22b of the groove 22 is larger, due to the larger width of the groove there, than the coil distance in the end sections 22a, 22c of the groove 12. Accordingly, in the area of the middle section 22b of the groove 22, a lower heating output is produced, wherein the resulting temperature profile, however, is different than in the embodiment of FIGS. 1a, 1b.

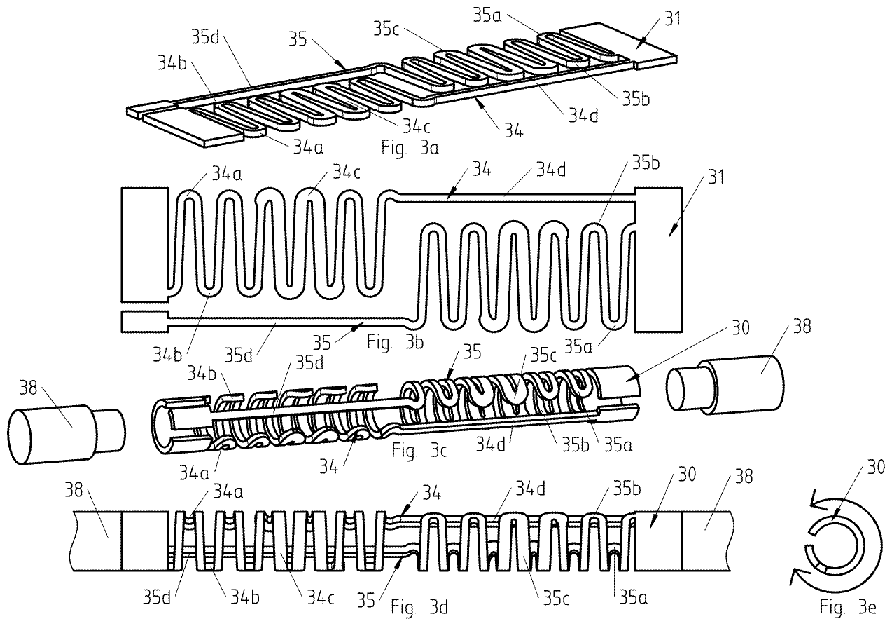

In principle, the electrical heating element 30 shown in FIGS. 3c and 3d could also be manufactured from a tubular heating element blank, but it would be significantly simpler to manufacture it from a plate-shaped heating element blank 31, which is rolled up according to the global transformation sketched in FIG. 3e. Here, the heating conductor can be formed, in particular, by a punching process in the plate-shaped heating element blank 31. In this way, a heating conductor of a first sub-heating conductor 34 and a second sub-heating conductor 35 are created, which are connected in series one behind the other. The first sub-heating conductor 34 initially has a meander-like profile on the tubular sheath of the heating element blank 31, wherein space is left between the respective turn-around sections 34a, 34b of the meander-like loops, through which a connection section 35d of the second sub-heating conductor 35 is guided in a straight line. In addition, the meander-like loops are realized in the section 34c with larger cross section.

The first sub-heating conductor 34 transitions, for example, in the half of the length of the heating element blank 31 into a connection section 34d. In this area, the second sub-heating conductor 35 has a meander-like shape on the tubular sheath of the heating element blank 31, wherein, however, the position of the meander-like loops of the second sub-heating conductor 35 on the tubular sheath is shifted by 90 degrees relative to the position of the meander-like loops of the first sub-heating conductor 34 on the tubular sheath, and the connection section 34d of the first sub-heating conductor 34 is in the space between the respective turn-around sections 35a, 35b of the meander-like loops. Furthermore, a section 35c is also present here in which the cross section of the meander-like loops is increased.

Because less heat is produced in the straight-line connection sections 34c, 35c than in the meander-like loops, the electrical heating element 30 has, over its length, two sections, each of which has anisotropic heat-emission characteristics relative to the tube axis, which also vary across the length, and whose orientations, however, are offset or rotated relative to each other by 90°. This relatively complex heating conductor can also be generated with relatively simple means.

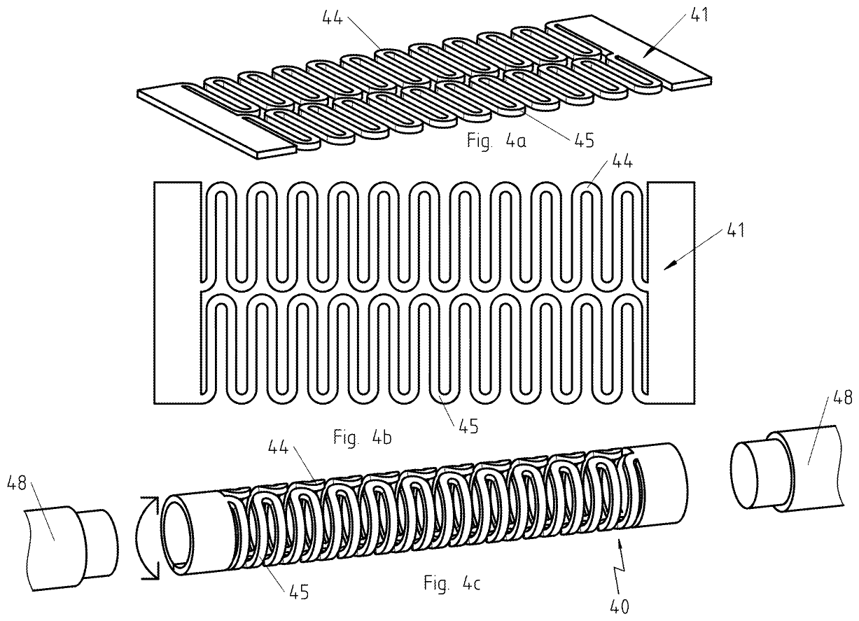

The embodiment of FIGS. 4a to 4c shows an electrical heating element 40, which can be obtained by rolling up a plate-shaped heating element blank 41. Here, the heating conductor, which is assembled from two sub-heating conductors 44, 45 that each have the same meander-like geometry in a parallel circuit, can be machined from the plate-shaped heating element blank 41 and has been produced by rolling up the electrical heating element 40.

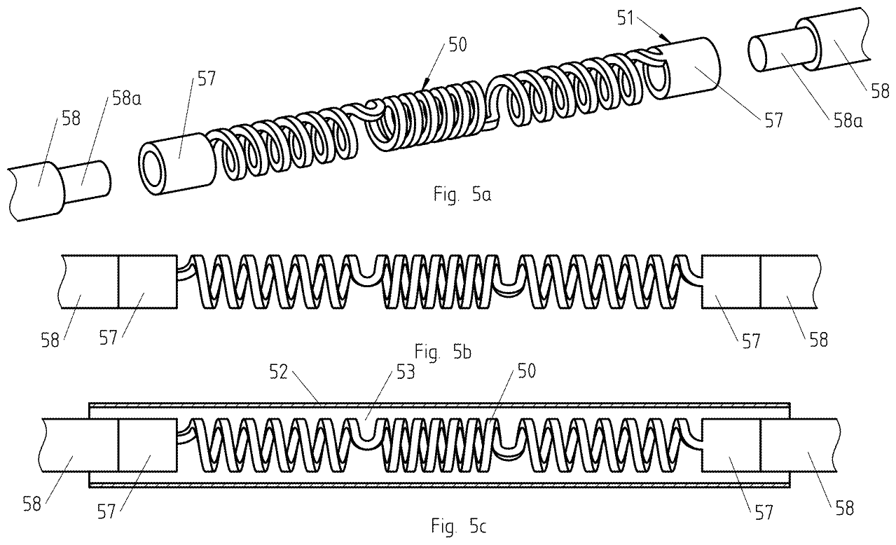

The electrical heating element 50 shown in FIGS. 5a to 5c is machined from a cylindrical heating element blank 51. Its heating conductor is assembled from three sub-heating conductors 54, 55, 56 connected in series, wherein the adjacent sub-heating conductors 54, 55, and 55, 56, respectively, each differ with respect to their coil pitch and their coil rotational direction. At both ends of the heating conductor there is a tubular connection section 57, through whose inner surface a large contact surface can engage for the contact section 58a of connector pin 58. FIG. 5c shows the electrical heating element 50 as part of an electrical heating device in the interior of a tubular metal sheath 52 and embedded in preferably compacted electrically isolating material 53.

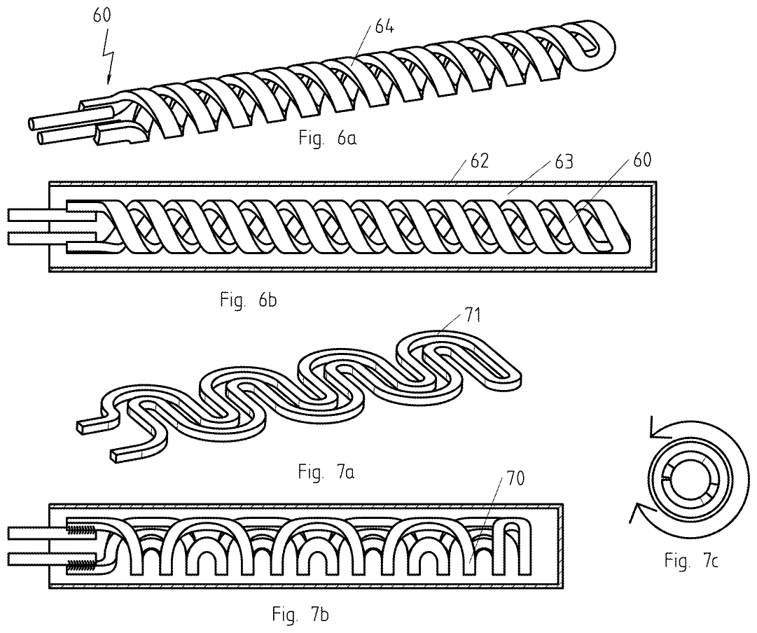

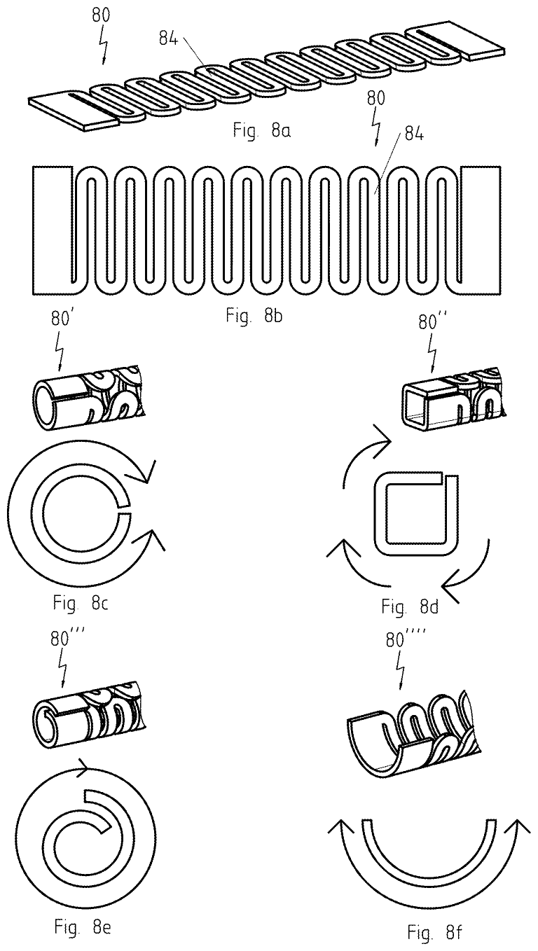

Bifilar heating conductors are interesting for a number of applications. FIG. 6a shows an electrical heating element 60 in the form of one such bifilar heating conductor 64, which is machined from a cylindrical heating element blank; FIG. 6b shows an electrical heating device with tubular metal sheath 62, in whose interior the heating element 60 is embedded in electrically isolating material 63.

As FIGS. 7a to 7c show, a bifilar winding can also be generated starting from a plate-shaped heating element blank 71, which can then by transformed globally by a rolling-up process to form the electrical heating element 70, which is then embedded in the tubular metal sheath 72 in electrically insulating material 73 and is connected electrically to connection wires 78.

In FIGS. 8a and 8b, two views of a simple electrical heating element 80 are shown, which has an essentially meander-like heating conductor 84, which is machined from a plate-shaped heating element blank. FIGS. 8c to 8f show different electrical heating elements 80′, 80″, 80′″, 80″″, which can be obtained through global geometric transformations, namely, rolling up with constant radius, folding into a square, rolling up with variable radius into an overlapping spiral structure, and bending from the plate-shaped heating element blank and also a schematic diagram of the corresponding transformations.

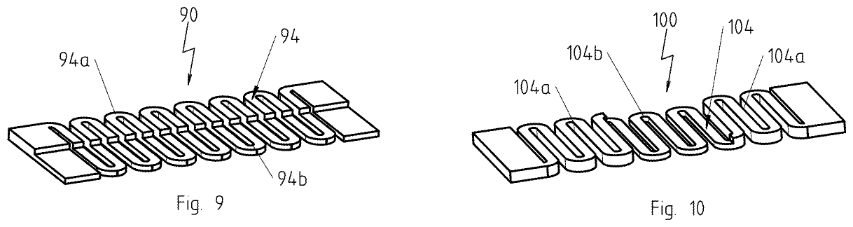

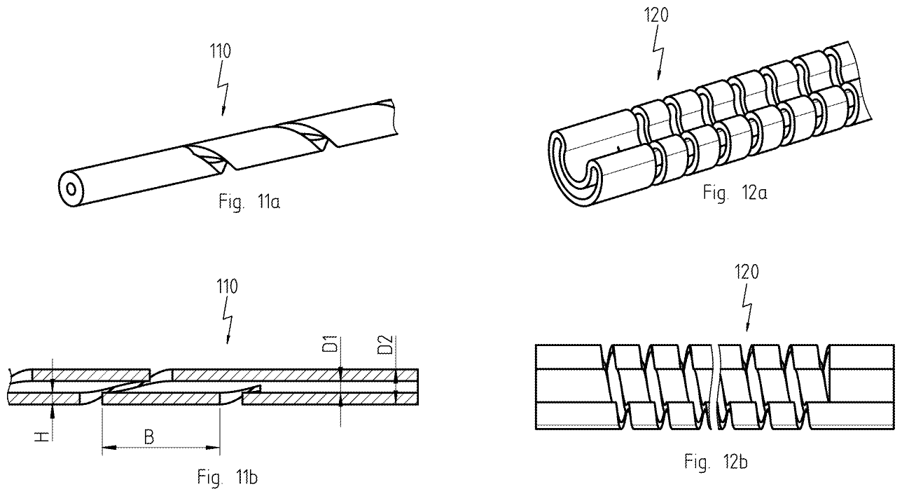

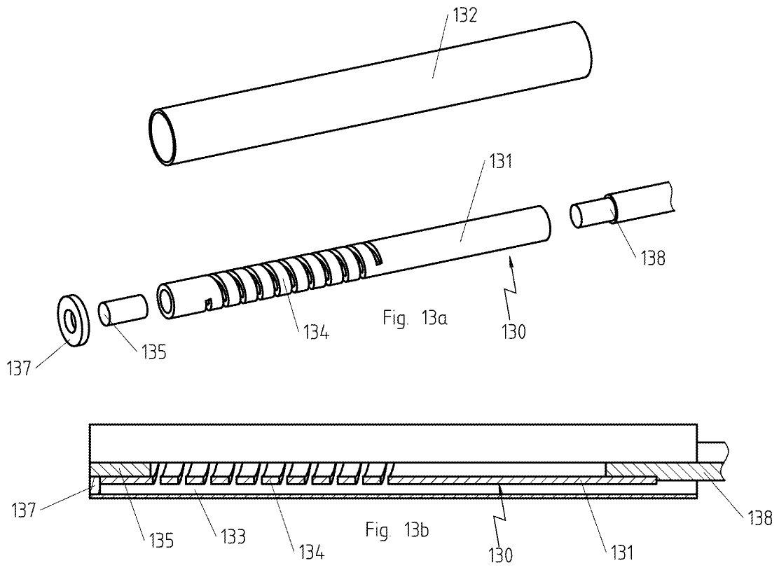

The electrical heating conductors 90 and 100 according to FIGS. 9 and 10, respectively, illustrate another option for machining electrical heating elements, which are based on plate-shaped heating element blanks. If such a blank is milled in certain sections, heating conductors 94, 104 with sections 94a, 104a, which have a larger cross section and sections 94b, 104b, which have a smaller cross section, can be produced in a simple way.

Through the machining of the electrical heating element from the heating element blank, as the electrical heating elements 110 and 120 according to FIGS. 11a, 11b and 12a, 12b show, respectively, structures can be manufactured that were previously not possible. Thus, as can be seen from FIGS. 11a and 11b, an electrical heating element 110 with a very high ratio of width of the winding cross section B to the height of the winding cross section H can be produced from a tube with narrow tube inner diameter D1 and only slightly larger tube outer diameter D2 by cutting a coil-shaped groove or, as can be seen in FIGS. 12a and 12b, a non-coilable, “dented” electrical heating element 120 can be produced.

The electrical heating element 130 shown in FIGS. 13a and 13b is part of an electrical heating device with a tubular metal sheath 132 used as the return line, electrically isolating material 133, contact pin 135, disk 137, and connection wire 138. The heating conductor 134 is produced starting from a tubular heating element blank 131 by means of milling of a groove in the heated area, while at both ends a tubular section remains, in order to guarantee a large contact surface on one side for the electrical contacting with the contact pin 135, which forms, by means of the electrically conductive disk 137, the electrical contact to the tubular metal sheath 132 used as the return line and on the other side to the connection wire 138.

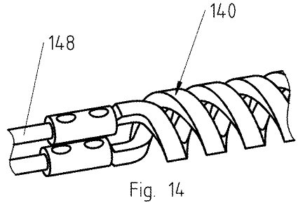

As the example of the electrical heating element 140 shown in FIG. 14 shows, connection sections can be formed, for example, for crimping with connection wires 148, directly as the end section of the heating element 140. While the previously shown electrical heating elements, which are based on plate-shaped heating element blanks, have had heating conductors of high complexity, which were associated with the removal of considerable amounts of material, this is not absolutely required. In fact, a plurality of technically relevant conductor configurations can also be realized extremely economically in terms of manufacturing through the simple formation of straight slots in such plate-shaped heating element blanks, which are then shaped globally.

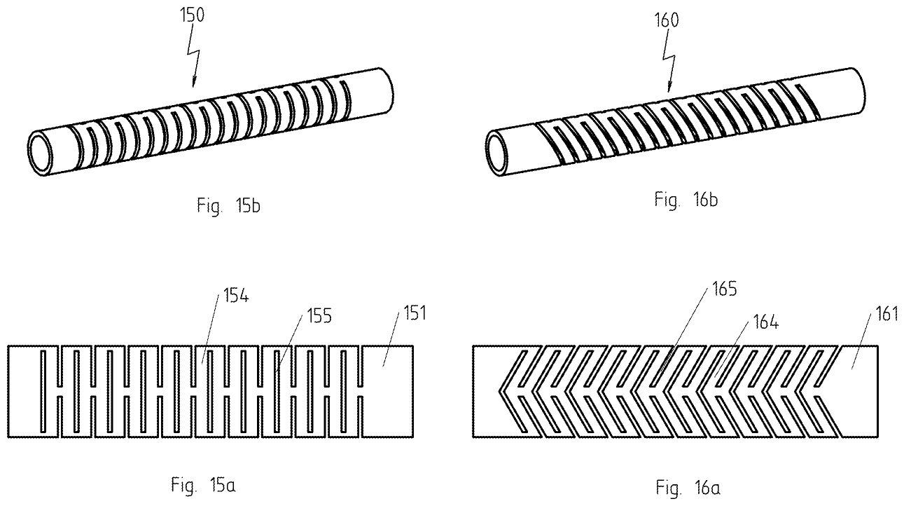

FIGS. 15a and 16a show plate-shaped heating element blanks 151, 161, whose heating conductors 154, 164 can be realized by an arrangement or two arrangements of essentially parallel cuts 155, 165 and can be made by rolling up to form the electrical heating elements 150, 160, which are shown in FIGS. 15b and 16b, respectively.

FIG. 17 shows an electrical heating 170, which can be produced according to this principle and whose heating conductor 174 has essentially a meander-like profile, as is already basically known, but must be realized with much more effort than by forming cuts in a plate-shaped heating element blank that is then rolled together.

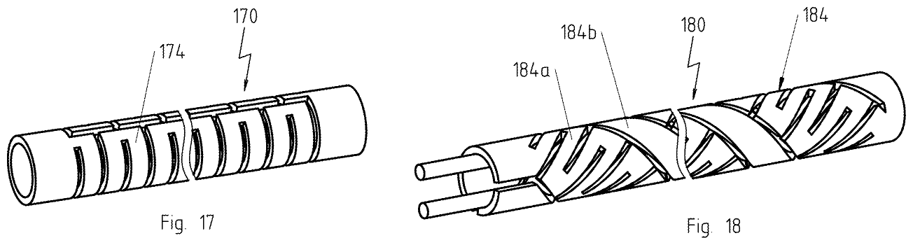

Novel, innovative profiles of the heating conductor can also be realized according to this simple principle. One example is the electrical heating element 180 according to FIG. 18, whose heating conductor 184 is realized by meander-like conductors 184a, which extend in a helical-line shape in a direction toward an imaginary cylindrical sheath, wherein a return line section 184b of the heating conductor 184 runs between the individual windings.

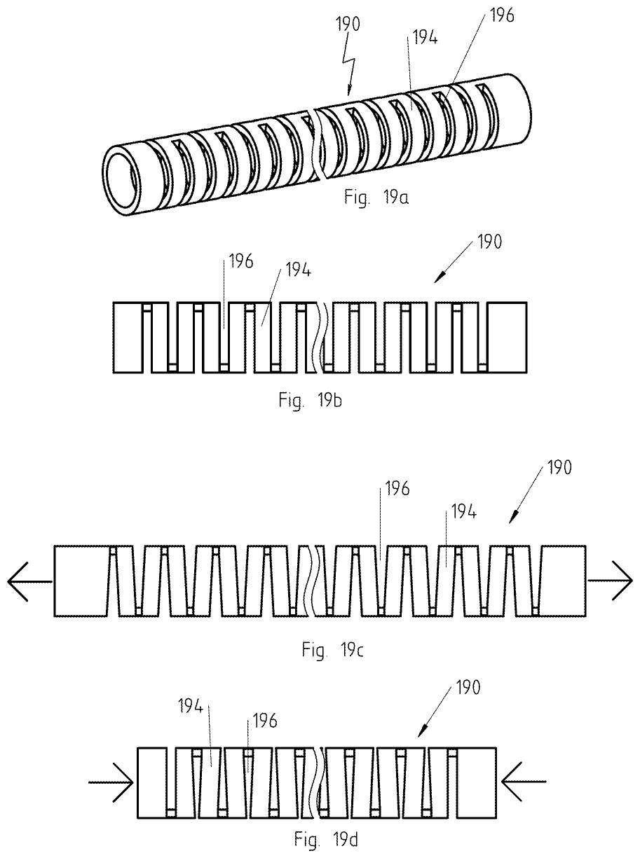

FIGS. 19a to 19d are used again to show the fact that, with the manufacturing principle according to the invention, electrical heating elements can be produced that are excellent at withstanding the mechanical loads that occur during temperature cycles. The electrical heating element 190 shown in FIG. 19a has a heating conductor 194, which can be formed essentially by parallel slots 196, which can be formed either in a plate-shaped heating element blank or in a cylindrical heating element blank. The side views of FIGS. 19b, 19c, and 19d, which show the electrical heating element 190 in the unloaded state, under tensile stress, and under compression, respectively, show how easily the electrical heating element 190 can sustain such loading.

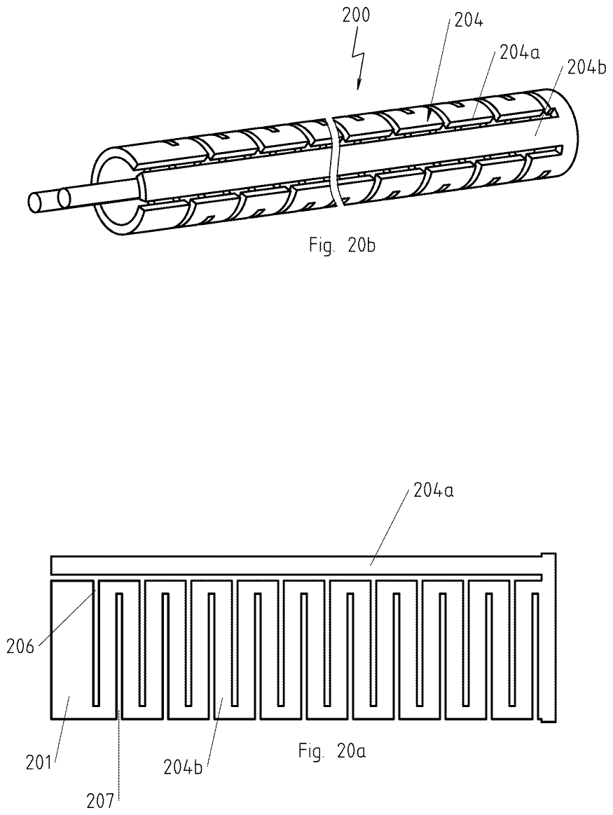

Also electrical heating elements, whose heating conductor has a return line section, can be realized with a simple configuration of linear cuts, as the embodiment of the electrical heating element 200 with a heating conductor 204, which consists of a meander-like section 204a and a return-line section 204b, according to FIGS. 20a and 20b, shows. The electrical heating element 200 is produced simply by rolling up a plate-shaped heating element blank 201, in which, on one hand, a comb-shaped section line 206 not passing completely through it in its extent direction and a series of cuts 207, which run centrally between the “teeth” of the comb defined by the comb-shaped cut line 206 and which extend from the longitudinal side of the plate-shaped heating element blank 201 farther removed from the “back” of the comb defined by the comb-shaped cut line 206.

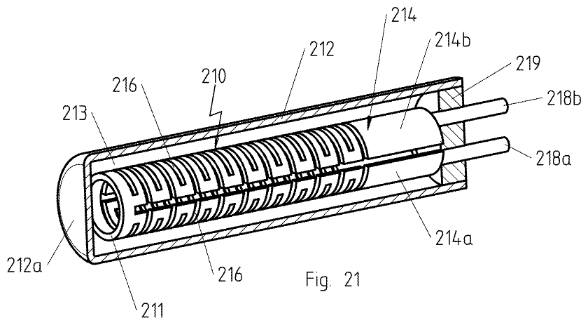

FIG. 21 shows another electrical heating element 210 with a heating conductor 214, which has a supply line section 214a and a return line section 214b in its installation situation as part of an electrical heating device within a tubular metal sheath 212 with base 212a embedded in electrically isolating material 213. Here, the heating conductor 214 is realized such that a tubular heating element blank 211 is almost completely separated along one of its middle planes, so that two half shells connected to each other only by a ring are produced, in which, for example, starting from the ring in the circumferential direction, slots 216 are formed, wherein adjacent slots 216 extend over different areas of the circumferential direction, in order to realize meander-like sections of the heating conductor 214 both in the supply line section 214a and also in the return line section 214b. These slots do not extend over the entire half shell, so that on the connection side, an unheated or weakly heated area of the half shells is produced, which simultaneously prepares a large contact surface for the connection of connection wires 218a, 218b, which are guided through a connection-side closing disk 219.

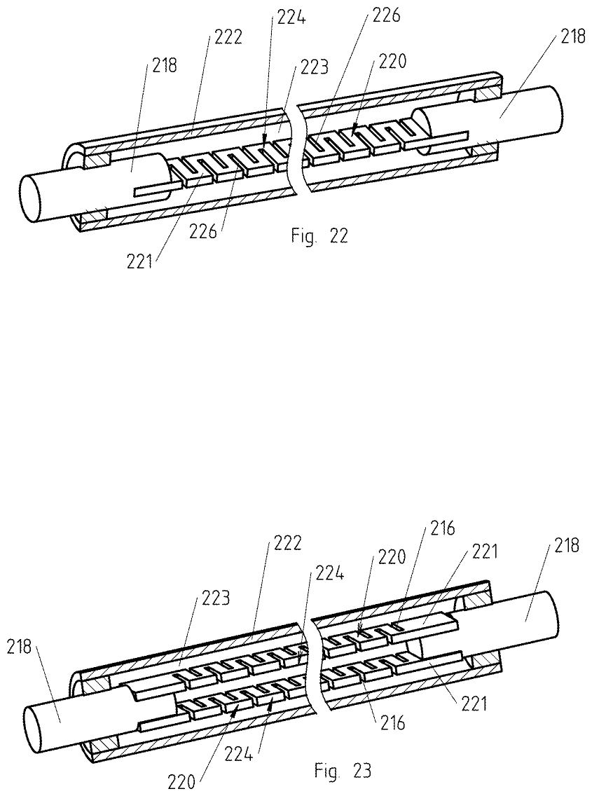

FIGS. 22 to 25 illustrate that, based on a very simple base shape of an electrical heating element 220, construction-kit-like electrical heating devices can be configured, which permits very economical series production of such electrical heating devices. This base shape of the electrical heating element 220 is obtained simply from a plate-shaped heating element blank 221, in which parallel cuts 226 are formed alternating from the two longitudinal sides, which do not pass completely through the heating element blank. This leads to a meander-like sub-heating conductor 224, which can be inserted in different configurations as part of very different heating conductors. The electrical heating element 220 is electrically contacted by connector pins 228.

FIG. 22 shows a simple variant in which such a contacted electrical heating element 220 is arranged within a tubular metal sheath 222 in electrically isolating material 223.

FIG. 23 shows a variant in which a stack of two such electrical heating elements 220 is arranged electrically connected in a parallel circuit within a tubular metal sheath 222 in an electrically isolating material 223. As can be easily imagined, such a stack can also include more electrical heating elements 220, which are held and electrically contacted as in FIG. 22 in grooves of the connector pins 228.

In addition to a parallel circuit, if there is an odd number of electrical heating elements 220, a series circuit can also be realized if they are isolated from each other alternately on the two sides—for example, by pushing the electrical heating elements 220 into isolating elements supported in grooves of the connector pins, so that adjacent electrical heating elements 220, which are in electrical contact with each other on the side of one connector pin 228, are electrically isolated from each other on the side of the other connector pin 228 so that a direct electrical contact is not produced, but the current can only flow by passing through the electrical heating elements.

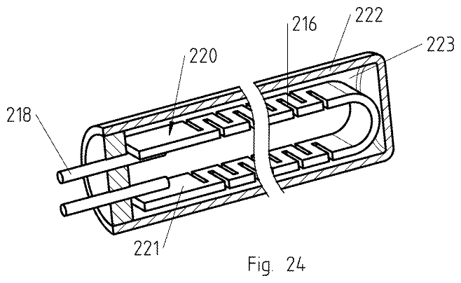

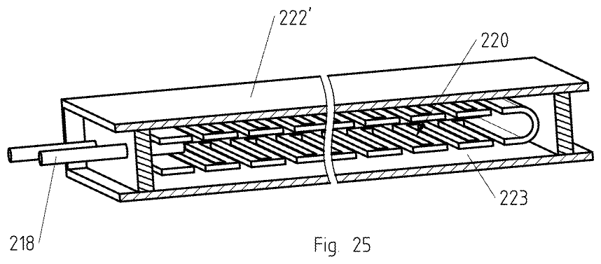

FIGS. 24 and 25 show embodiments of electrical heating devices in which the electrical heating element is bent into a U-shape—naturally, a curved arrangement is also conceivable in which it is embedded in electrically isolating material 223 and embedded in a metal sheath 222, 222′ electrically contacted with connector pin 228. The difference is that the housing 222 is a cylindrical housing, while the housing 222′ defines a flat heating element.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

### LIST OF REFERENCE SYMBOLS

10, 20, 30, 40, 50, 60, 70, 80, 90,
100, 110, 120, 130, 140, 150, 160,
170, 180, 190, 200, 210, 220 Electrical heating element
11, 21, 31, 41, 51, 61, 71, 81, 91,
101, 111, 121, 131, 141, 151, 161,
171, 181, 191, 201, 211, 221 Heating element blank
34, 35, 44, 45, 54, 55, 56, 224 Sub-heating conductor
64, 84, 94, 104, 134, 154, 164,
174, 184, 194, 204, 214 Heating conductor

1-18. (canceled)

19. A method for manufacturing an electrical heating element, especially for electrical heating devices and load resistors, the method including the steps of:
defining at least one heating conductor;
preparing a heating element blank with geometric dimensions that are selected such that the defined at least one heating conductor can be arranged in a sub-volume of space taken up by material of the heating element blank; and
machining the heating element blank so that the defined at least one heating conductor is generated by removing material from the heating element blank.

20. The method according to claim 19, wherein the machining of the heating element blank is comprised of a metal-cutting process, the metal-cutting process comprised of at least one of laser cutting, fine laser cutting, water jet cutting, punching, through fine punching, and through etching.

21. The method according to claim 19, including the step of:
preparing the heating element blank to have one of a plate-like, block-like, cylindrical, and tubular shape.

22. The method according to claim 19, including the step of:
preparing the heating element blank to have one of sections and layers that are comprised of one of different materials and contain different materials.

23. The method according to claim 19, wherein the heating element blank is prepared to have a section comprised of a resistive alloy with a temperature coefficient of greater than three hundred parts per million per degrees centigrade (>300 ppm/° C.).

24. The method according to claim 23, wherein the temperature coefficient is greater than one thousand parts per million per degrees centigrade (>1000 ppm/° C.).

25. The method according to claim 24, wherein the temperature coefficient is greater than three thousand parts per million per degree centigrade (>3000 ppm/° C.).

26. The method according to claim 19, wherein the heating element blank has sections with different thickness.

27. The method according to claim 19, wherein the at least one heating conductor has a flat profile.

28. The method of according to claim 19, wherein the at least one heating conductor is defined by a global geometric transformation, in particular by one of unrolling and unfolding from a final heating conductor and the machined heating element blank is subjected to an inverse geometric transformation, in particular, one of rolling up and folding together in order to bring the electrical heating element into a shape, in which the electrical heating element has the final heating conductor.

29. The method according to claim 19, wherein the at least one heating conductor is defined so to have sections of different width so that the at least one heating conductor is widened and narrowed locally.

30. The method according to claim 19, wherein the at least one heating conductor is defined to have sections of different thickness.

31. The method according to claim 19, wherein the at least one heating conductor is defined to have a coiled profile in some sections, the coiled profile having a varied coil pitch.

32. The method according to claim 19, wherein the at least one heating conductor is defined to have a coiled profile in some sections, the coiled profile having a varied rotational direction of coils in the coiled profile.

33. The method according to claim 19, wherein the at least one heating conductor is defined to have contact surfaces for electrical connections.

34. The method according to claim 19, wherein the at least one heating conductor is defined to have at least one series circuit of sub-heating conductors and a parallel circuit of sub-heating conductors.

35. The method according to claim 19, wherein the at least one heating conductor is defined to have at least two heating circuits separated from each other.

36. The method according to claim 19, wherein the at least one heating conductor is defined to have sections that can be switched separately from each other.

37. The method according to one of claim 19, wherein the at least one heating conductor is defined to have at least one bifilar section.

38. The method according to claim 19, wherein the at least one heating conductor is defined to sustain mechanical effects of thermal load cycling.
